(19) United States
(12) Patent Application Publication
(10) Pub. No.: US 2009/0289736 A1
(43) Pub. Date: Nov. 26, 2009

(54) MAGNETIC SWITCHES FOR SPINWAVE TRANSMISSION

(75) Inventors: Haiwen Xi, Prior Lake, MN (US); Dadi Setiadi, Edina, MN (US); Insik Jin, Eagan, MN (US); Yang Li, Shoreview, MN (US); Song Xue, Edina, MN (US)

Correspondence Address: CAMPBELL NELSON WHIPPS, LLC, HISTORIC HAMM BUILDING, 408 SAINT PETER STREET, SUITE 240, ST. PAUL, MN, 55102, US

(73) Assignee: SEAGATE TECHNOLOGY LLC, Scotts Valley, CA (US)

(21) Appl. No.: 12/125,974

(22) Filed: May 23, 2008

(51) Int. Cl. H01P 1/10; H01H 53/00

(52) U.S. Cl. 333/105; 335/4

(57) ABSTRACT

Spinwave transmission systems that include switching devices to direct the transmission of the spinwaves used for data transfer and processing. In one particular embodiment, a system for spinwave transmission has a first magnetic stripe configured for transmission of a spinwave and a second magnetic stripe for transmission of the spinwave, with a gap therebetween. The system includes a coupler that has a first orientation and a second orientation, where in the first orientation, no magnetic connection is made between the magnetic stripes, and in the second orientation, a connection is made between the magnetic stripes. The connection allows transmission of the spinwave from the first magnetic stripe to the second magnetic stripe. The first and second orientation may be the physical position of the coupler, moved by thermal, piezoelectric, or electrostatic forces, or, the first and second orientation may be a magnetic state of the coupler.

### BACKGROUND

The direction of today's progress is to miniaturize semiconductor electronic devices. A major factor in the design of very large-scale integration (VLSI) chips is the copper connections between elements. These connections or interconnects have several disadvantages. Not only are the interconnects costly to manufacture, but in use, they utilize a large amount of the energy needed to power the chips, in many cases more than the transistors themselves consume. Additionally, copper interconnects occupy a large volume of space. Much research and development has been focused on replacing copper interconnects on chips.

What is needed is an alternate to copper interconnects for transmission of data.

### BRIEF SUMMARY

The present disclosure provides spinwave transmission and propagation systems that include switching devices to direct the transmission of the spinwaves. These systems can be used for data transfer and processing. In one particular embodiment, a system for spinwave transmission is provided, the system have a first magnetic stripe or element configured for transmission of a spinwave and a second magnetic stripe or element for transmission of the spinwave, with a gap therebetween. The system includes a coupler that has a first orientation and a second orientation, where in the first orientation, no magnetic connection is made between the first magnetic stripe or element and the second magnetic stripe or element, and in the second orientation, a connection is made between the first magnetic stripe or element and the second magnetic stripe or element. The connection allows transmission of the spinwave from the first magnetic stripe to the second magnetic stripe. The first and second orientation may be the physical position of the coupler, moved by thermal, piezoelectric, or electrostatic forces, or, the first and second orientation may be a magnetic state of the coupler.

These and various other features and advantages will be apparent from the following detailed description.

### BRIEF DESCRIPTION OF THE DRAWINGS

The invention may be more completely understood in consideration of the following detailed description of various embodiments of the invention in connection with the accompanying drawings, in which:

FIG. 1 is a schematic perspective view of a first embodiment of a magnetic switch for spinwave transmission.

FIG. 2A is a schematic side view of the magnetic switch of FIG. 1 in a first position. FIG. 2B is a schematic side view of the magnetic switch of FIG. 1 in a second position.

FIG. 3A is a schematic side view of a second embodiment of a magnetic switch for spinwave transmission in a first position. FIG. 3B is a schematic side view of the magnetic switch of FIG. 3A in a second position.

FIG. 4 is a schematic perspective view of a third embodiment of a magnetic switch for spinwave transmission.

FIG. 5 is a schematic perspective view of a fourth embodiment of a magnetic switch for spinwave transmission.

FIG. 6 is a schematic perspective view of a fifth embodiment of a magnetic switch for spinwave transmission.

FIG. 7 is a schematic perspective view of a sixth embodiment of a magnetic switch for spinwave transmission.

FIG. 8 is a diagram of a magnetic router having a crossbar structure made of multiple magnetic stripes.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Spinwaves are a potential alternate to copper interconnects on chips for transmission of data. Spinwaves are the magnetization perturbations in a magnetic structure in a form of waves. Spinwaves are similar to acoustic waves in a medium (e.g., gas) and to electromagnetic waves (e.g., light) in a vacuum. An acoustic wave is the coherent displacement of the atoms in the medium. A spinwave is the coherent displacement of atoms in a ferromagnetic material. A ferromagnet can be viewed as a lattice of atoms, each of which has magnetic moment that can rotate in space. These magnetic moments are exchange coupled, similar to atoms in a solid material linked by elastic coupling. The orientation of a magnetic moment is influenced by that of neighboring moments. A spinwave is the orientation of the local magnetic moments as a wave form that can travel through the ferromagnet. A spinwave can be generated by spin polarized current, but it is not spin polarized current.

A spinwave can be used to transmit data. Data is coded in spinwaves in the amplitude, the frequency, or the phase of the spinwaves. Data transmission is then accomplished by spinwave transmission along a magnetic stripe or element, also referred to as a spinwave bus. The formation and transmission of spinwaves rely on the coupling of the adjacent magnetic moments in the magnetic stripes.

Spinwave propagation along magnetic stripes or spinwave buses is a promising approach to replace copper interconnections and to overcome the obstacles of copper interconnections. The following description provides various embodiments of switches for spinwave magnetic stripes and the transmission of spinwaves.

In the following description, reference is made to the accompanying set of drawings that form a part hereof and in which are shown by way of illustration several specific embodiments. It is to be understood that other embodiments are contemplated and may be made without departing from the scope or spirit of the present invention. The following detailed description, therefore, is not to be taken in a limiting sense. While the present invention is not so limited, an appreciation of various aspects of the invention will be gained through a discussion of the examples provided below.

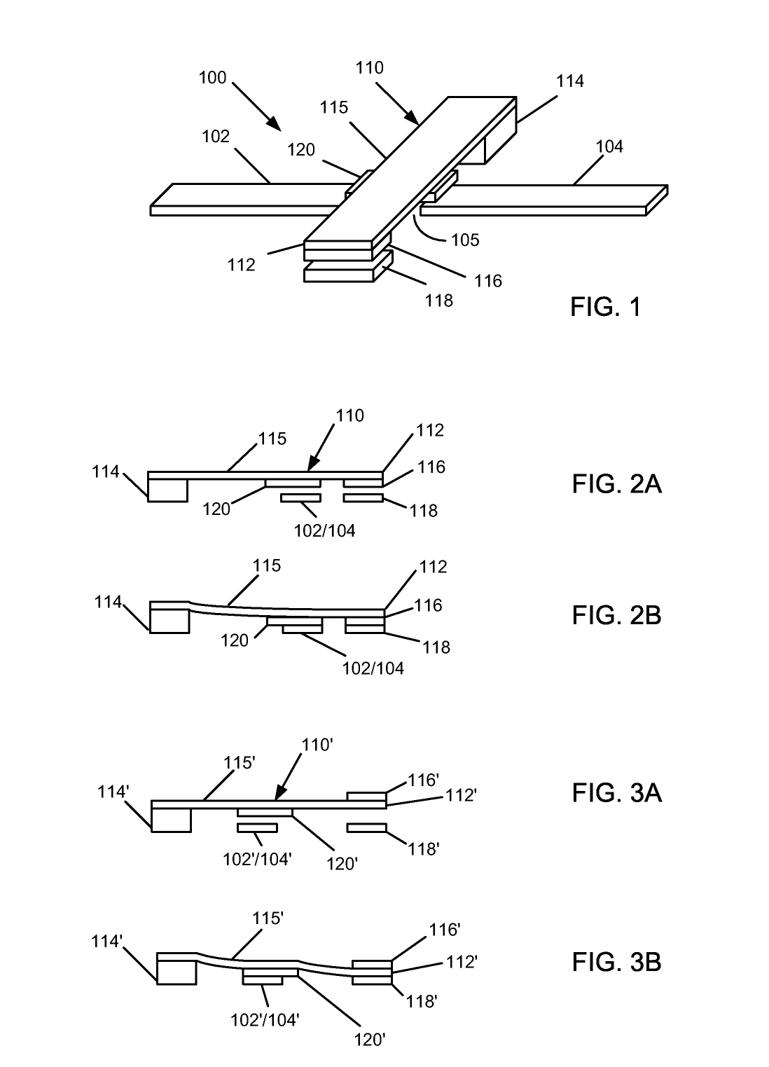

Referring to FIGS. 1 and 2A and 2B, an embodiment of a spinwave system in accordance with the present disclosure is schematically and diagrammatically illustrated. This system utilizes electrostatic forces to activate a switch and transmit the spinwaves from one location to another. Although not illustrated herein, the spinwave system is formed on a substrate, and may be electrically connected to additional spinwave systems and devices.

As best seen in FIG. 1, system 100 has a first magnetic stripe or bus 102 and a second magnetic stripe or bus 104, co-planar and generally aligned. Stripes 102, 104 may alternately be referred to as strips, traces, tracks, elements, members, or the like. Stripes 102, 104 are ferromagnetic and are magnetically conductive. Stripes 102, 104 may be electrically conducting or insulating; in some embodiments, it may be desired to have stripes 102, 104 be an insulating ferromagnetic material to avoid eddy currents that result due to energy dissipation and/or thermal issues. Examples of suitable materials for stripes 102, 104 include Fe, Co, Ni, and their alloys, although other types of ferromagnetic materials would be suitable. In many embodiments, stripes 102, 104 are less than about 500 nm in width.

Stripe 102 is physically and magnetically spaced from stripe 104, leaving a gap 105 therebetween. Gap 105 is non-magnetic, in many embodiments electrically non-conductive, and in most embodiments, gap 105 has air therein. Gap 105 is sufficiently large to disrupt the local exchange coupling from stripe 102 to stripe 104. The width of gap 105 is dependant on the manufacturing capabilities of system 100, but in many embodiments, gap 105 is no larger than about 100 nm.

System 100 includes a coupler in close proximity to each of stripe 102 and stripe 104 to magnetically connect stripe 102 to stripe 104 when the coupler is engaged. In many embodiments, the coupler, when not engaged with stripes 102, 104, is positioned, for example, about 20 nm from strips 102, 104.

System 100 has a bridging structure 110 extending over and supporting a magnetic coupler 120 across gap 105. Bridging structure 110 is a cantilevered structure, having a body 115 with a first, free end 112 and a second, supported end 114. Present at free end 112 is an electrode 116, positioned for electrical contact with a base electrode 118 distanced from bridging structure 110 and electrode 116. Electrode 116 is present on the side of body facing stripes 102, 104. Magnetic coupler 120 is positioned between free end 112 and supported end 114, also on the side of body 115 facing stripes 102, 104.

Bridging structure 110 is configured to have free end 112 move vertically (i.e., orthogonal to stripes 102, 104) to bring magnetic coupler 120 in contact with each of stripe 102 and stripe 104 simultaneously. See FIGS. 2A and 2B. In FIG. 2A, bridging structure 110 is in a first position, with magnetic coupler 120 not in physical or magnetic contact with stripes 102, 104. In FIG. 2B, bridging structure is in a second position, with magnetic coupler 120 in physical and magnetic contact with each of stripes 102, 104. When in the second position, magnetic coupler 120 provides magnetic continuity between stripes 102, 104, thus allowing transmission of spinwaves across gap 105 (FIG. 1).

To move bridging structure 110 from the first position of FIG. 2A to the second position of FIG. 2B, a voltage or current is applied to at least one electrode 116 or electrode 118. The electrostatic force between electrodes 116, 118 pulls electrodes 116, 118 together and thus distorts body 115 of bridging structure 110 until magnetic coupler 120 engages stripe 102 and stripe 104. When the voltage or current is removed, body 115 and bridging structure 110 recover to the first position and magnetic connection is broken.

An alternate embodiment of a system that utilizes electrostatic forces to activate a switch and transmit spinwaves is illustrated in FIGS. 3A and 3B. This system is similar to system 100 discussed above, except for the placement of one of the electrodes.

A bridging structure 110′ extends over and supports a magnetic coupler 120′ across a gap present between magnetic stripe 102′ and magnetic stripe 104′. Bridging structure 110′ is a cantilevered structure, having a body 115′ with a first, free end 112′ and a second, supported end 114′. At free end 112′ is an electrode 116′ present on the opposite side of body 115′ than magnetic coupler 120′. A base electrode 118′ is positioned distanced from bridging structure 110′ and electrode 116′.

Bridging structure 110′ is configured to have free end 112′ move vertically to bring magnetic coupler 120 in contact with each of stripe 102′ and stripe 104′ simultaneously. In FIG. 3A, bridging structure 110′ is in a first position, with magnetic coupler 120′ not in physical or magnetic contact with stripes 102′, 104′. In FIG. 3B, bridging structure is in a second position, with magnetic coupler 120′ in physical and magnetic contact with each of stripes 102′, 104′. When in the second position, magnetic coupler 120′ provides magnetic continuity between stripes 102′, 104′.

To move bridging structure 110 from the first position of FIG. 2A to the second position of FIG. 2B, a voltage or current is applied to at least one electrode 116 or electrode 118. The electrostatic force between electrodes 116, 118 pulls electrodes 116, 118 together and thus distorts body 115 of bridging structure 110 until magnetic coupler 120 engages stripe 102 and stripe 104. When the voltage or current is removed, body 115 and bridging structure 110 recover to the first position and magnetic connection is broken.

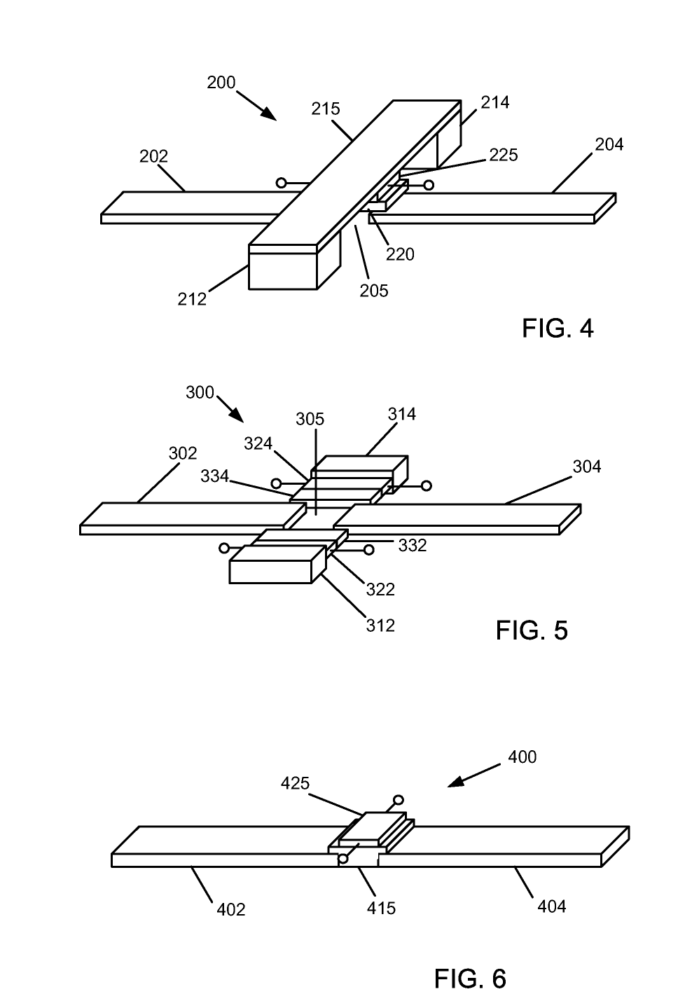

Various alternative configurations for spinwave transmission systems having a magnetic coupler between stripes or buses are illustrated in FIGS. 4 through 7. The various elements of the systems of FIGS. 4 through 7 have the same properties and qualities as the respective elements of system 100, unless otherwise indicated.

In FIG. 4, a system utilizes a piezoelectric element to activate a switch and transmit spinwaves. System 200 has a first magnetic stripe or bus 202 and a second magnetic stripe or bus 204, both which are ferromagnetic and are magnetically conductive. Stripes 202, 204 are physically and magnetically spaced, leaving a gap 205 therebetween. Gap 205 is non-magnetic, in many embodiments electrically non-conductive, and in most embodiments, gap 205 has air therein. Gap 205 is sufficiently large to disrupt the local exchange coupling from stripe 202 to stripe 204. System 200 includes a magnetic coupler in close proximity to each of stripe 202 and stripe 204 to magnetically connect stripe 202 to stripe 204 when the coupler is engaged.

System 200 has a bridging structure 210 extending over and supporting a magnetic coupler 220 across gap 205. Bridging structure 210 has a body 215 with a first end 212 and an opposite second end 214. Magnetic coupler 220 is positioned between first end 212 and second end 214, on the side of body 215 facing stripes 202, 204. A piezoelectric element 225 connects magnetic coupler 220 to body 215.

To move bridging structure 210 from a first position where magnetic contact is not made between magnetic coupler 220 and stripes 202, 204 to a second position where magnetic contact is made, a voltage is applied to piezoelectric element 225. The voltage induces a strain in element 225 and the connected body 215. This strain forces body 215 and magnetic coupler 220 to move down, engaging stripe 202 and stripe 204 and creating magnetic continuity. When the voltage is removed, body 215 recovers to the first position and magnetic connection is broken. An example of a suitable piezoelectric material for element 225 is lead zirconate titanate.

Similar to system 200 of FIG. 4, a system that utilizes at least one piezoelectric element to activate a magnetic switch and transmit spinwaves is illustrated in FIG. 5 as system 300. System 300 has a first magnetic stripe or bus 302 and a second magnetic stripe or bus 304, both which are ferromagnetic and are magnetically conductive. Stripes 302, 304 are physically and magnetically spaced, leaving a gap 305 therebetween. Gap 305 is non-magnetic, in many embodiments electrically non-conductive, and in most embodiments, gap 305 has air therein. Gap 305 is sufficiently large to disrupt the local exchange coupling from stripe 302 to stripe 304. System 300 includes at east one magnetic coupler in close proximity to each of stripe 302 and stripe 304 to magnetically connect stripe 302 to stripe 304 when the coupler is engaged.

On one side of stripes 302, 304 is a first coupling structure that includes a stop 312, a piezoelectric element 322 and a magnetic coupler 332. Piezoelectric element 322 is positioned between and operably connected to stop 312 and magnetic coupler 332. Stop 312 is fixed in relation to stripes 302, 304 whereas piezoelectric element 322 and coupler 332 can move in relation to stripes 302, 304.

On the other side of stripes 302, 304 is a second coupling structure that includes a stop 314, a magnetic coupler 334, and a piezoelectric element 324 positioned between and operably connected to stop 314 and magnetic coupler 334. Stop 314 is fixed in relation to stripes 302, 304 whereas piezoelectric element 324 and coupler 334 can move in relation to stripes 302, 304.

To move magnetic coupler 332 from a first position where magnetic contact is not made between magnetic coupler 332 and stripes 302, 304 to a second position where magnetic contact is made, a voltage is applied to piezoelectric element 322. The voltage induces a strain in element 322 and forces magnetic coupler 332 to move away from stop 312, engaging stripe 302 and stripe 304 and creating magnetic continuity. When the voltage is removed from piezoelectric element 322, magnetic coupler 332 recovers to the first position and magnetic connection is broken. Similarly, to move magnetic coupler 334 from a first position to a second position, a voltage is applied to piezoelectric element 324. The resulting strain moves magnetic coupler 334 away from stop 314, engaging stripe 302 and stripe 304 and creating magnetic continuity. When the voltage is removed from piezoelectric element 324, magnetic coupler 334 recovers to the first position and magnetic connection is broken.

In FIG. 6, a system that utilizes thermal energy to activate a switch and transmit spinwaves is illustrated. System 400 has a first magnetic stripe or bus 402 and a second magnetic stripe or bus 404, both which are ferromagnetic and are magnetically conductive. Stripes 402, 404 are physically and magnetically spaced. The distance between stripes 402, 404 is sufficiently large to disrupt the local exchange coupling from stripe 402 to stripe 404. A coupler 415 is positioned between stripe 402 and stripe 404, extending between and contacting each of stripes 402 and 404.

Unlike the systems of the previous embodiments, the magnetic state of coupler 415 is temperature dependent. At a first temperature (e.g., room temperature), coupler 415 is antiferromagnetic and is not magnetically conductive, so that spinwaves do not propagate from stripe 402 to stripe 404. At a second temperature (e.g., a temperature greater than the first temperature), coupler 415 is ferromagnetic, to allow spinwaves to propagate across the distance between stripes 402, 404.

An example of a material for coupler 415 is an FeRh alloy, which has an abrupt magnetic state transition dependent on its temperature. At room temperature, the FeRh alloy is antiferromagnetic so that coupler 415 is at an “off” state magnetically and spinwaves can not propagate across stripe 402 to stripe 404. When the FeRh alloy is heated, for example by an adjacent heater, to above the transition temperature, it becomes ferromagnetic, so that coupler 415 is “on” and spinwaves can pass through.

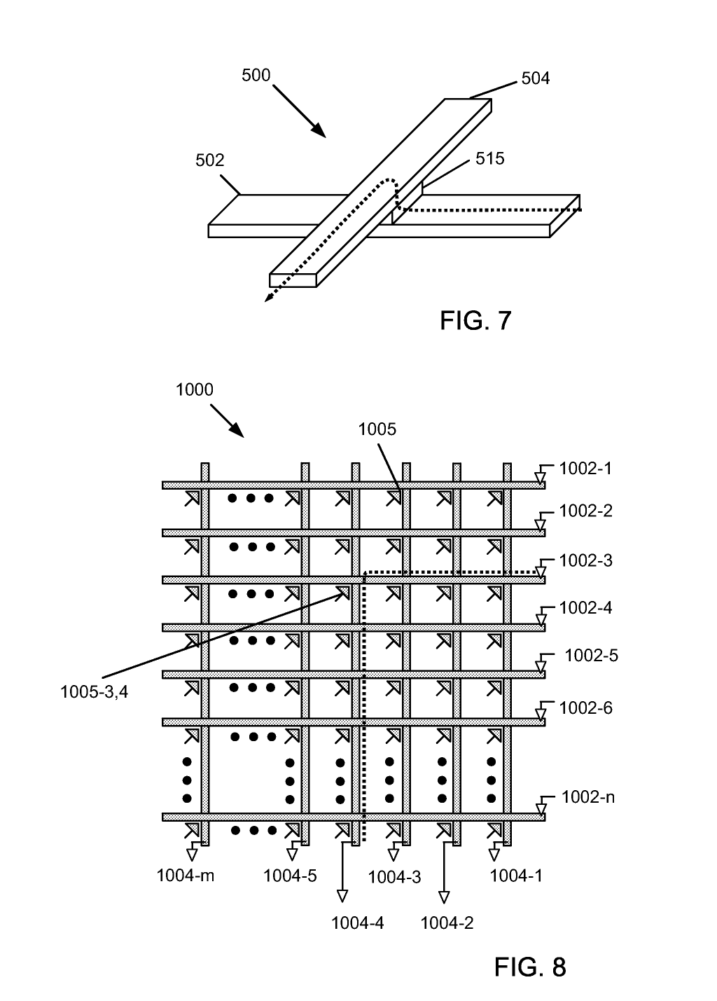

A coupler that has two different magnetic states can be used in other configurations of systems for the transmission of spinwaves. Illustrated in FIG. 7 is a system 500 that has a first magnetic stripe or bus 502 and a second magnetic stripe or bus 504, both which are ferromagnetic and are magnetically conductive. In this system, stripes 502, 504 are not co-planar and are orthogonal to each other. Stripes 502, 504 are physically and magnetically spaced apart to disrupt the local exchange coupling from stripe 502 to stripe 504. A coupler 515 is positioned proximate the intersection between stripe 502 and stripe 504, and extends between and contacts each of stripes 502 and 504.

As in system 400, the magnetic state of coupler 515 is temperature dependent. An example of a material for coupler 515 is an FeRh alloy, which has two magnetic states dependent on its temperature. When coupler 515 is magnetic, data carried by the spinwaves can transfer from magnetic stripe 502 to strip 504.

The various elements of the systems described above (e.g., system 100, system 200, system 300, etc.) can be made using conventional thin film processes and standard MEMS processes.

FIG. 8 illustrates a magnetic router (e.g., a switch array) with a crossbar structure made of multiple magnetic stripes. Magnetic router 1000 has a plurality of input stripes 1002 and a plurality of output magnetic stripes 1004 positioned orthogonal to and in a parallel plane to input stripes 1002. Magnetic router 1000 has n import stripes 1002 (e.g., stripes 1002-1, 1002-2, 1002-3, 1002-4, 1002-5, 1002-6, . . . 1002-n) and m output stripes 1004 (e.g., stripes 1004-1, 1004-2, 1004-3, 1004-4, 1004-5, . . . 1004-m). A switch 1005 is at each cross-point of stripes 1002, 1004. Data carried by a spinwave from a certain input port will be directed to the destiny output port when a corresponding switch is “on” and that allows the spinwave to pass through. For example, a spinwave can enter on input stripe 1002-3, and if switch 1005-3,4 is “on”, the spinwave can exit on output stripe 1004-4.

In some embodiments, router 1000 can operate in a parallel mode with multiple simultaneous data transmissions.

Thus, numerous embodiments of the MAGNETIC SWITCHES FOR SPINWAVE TRANSMISSION are disclosed. The implementations described above and other implementations are within the scope of the following claims. One skilled in the art will appreciate that the present invention can be practiced with embodiments other than those disclosed. The disclosed embodiments are presented for purposes of illustration and not limitation, and the present invention is limited only by the claims that follow.

What is claimed is:

1. A system for spinwave transmission comprising:
a first magnetic stripe configured for transmission of a spinwave;
a second magnetic stripe for transmission of the spinwave, the second magnetic stripe spaced from the first magnetic stripe;
a coupler having a first orientation and a second orientation, where in the first orientation, no connection is present between the first magnetic stripe and the second magnetic stripe, and in the second orientation, a connection that allows spinwave transmission is present between the first magnetic stripe and the second magnetic stripe.

2. The system of claim 1, wherein the connection between the first magnetic stripe and the second magnetic strip is a magnetic connection.

3. The system of claim 1, where in the first orientation the coupler has a first physical position and in the second orientation the coupler has a second physical position different than the first physical position.

4. The system of claim 3, wherein the coupler is movable from the first physical position to the second physical position via electrostatic force.

5. The system of claim 3, wherein the coupler is movable from the first physical position to the second physical position by a strain induced by a piezoelectric element.

6. The system of claim 1, where in the first orientation the coupler is non-magnetic and in the second orientation the coupler is magnetic.

7. The system of claim 6, wherein the coupler comprises an FeRh alloy.

8. A system for spinwave transmission comprising:
a first magnetic element configured for transmission of a spinwave;
a second magnetic element for transmission of the spinwave, the second magnetic element spaced from the first magnetic element;
a magnetic coupler movable from a first position to a second position, when in the first position, the magnetic coupler contacts no more than one of the first magnetic element and the second magnetic element, and when in the second position, the magnetic coupler is in contact with each of the first magnetic element and the second magnetic element.

9. The system of claim 8, wherein the magnetic coupler is movable from the first physical position to the second physical position via electrostatic force.

10. The system of claim 9, wherein the magnetic coupler is present on a bridging structure having a first end and a second opposite end, with the magnetic coupler present on a surface of the bridging structure facing the magnetic strips.

11. The system of claim 10, wherein the bridging structure is a cantilever, with the first end fixed and the second end free.

12. The system of claim 11, wherein the second end has a first electrode thereon, and the system further comprises a second electrode positioned below the bridging structure.

13. The system of claim 13, wherein the first electrode is on the surface of the bridging structure facing the magnetic elements.

14. The system of claim 13, wherein the first electrode is on a surface of the bridging structure opposite the surface facing the magnetic elements.

15. The system of claim 8, wherein the magnetic coupler is movable from the first physical position to the second physical position by a strain induced by a piezoelectric element.

16. The system of claim 15, wherein the magnetic coupler is supported by a bridging structure, with the piezoelectric element present between the bridging structure and the magnetic coupler on a surface of the bridging structure facing the magnetic elements.

17. The system of claim 15, wherein the magnetic coupler and the piezoelectric element are present on a side adjacent the first magnetic element and the second magnetic element.

18. The system of claim 17 further comprising a second magnetic coupler and a second piezoelectric element, the second magnetic coupler and the second piezoelectric element present on a second side adjacent the first magnetic element and the second magnetic element.

19. A system for spinwave transmission comprising:
a first magnetic stripe configured for transmission of a spinwave;
a second magnetic stripe for transmission of the spinwave, the second magnetic stripe spaced from the first magnetic stripe;
a coupler contacting each of the first magnetic stripe and the second magnetic stripe, the coupler not transmitting spinwaves at a first temperature and transmitting spinwaves at a second temperature different than the first temperature.

20. The system of claim 19 wherein the coupler is non-magnetic at the first temperature and magnetic at the second temperature.

21. The system of claim 19, wherein the first temperature is less than the second temperature.

22. The system of claim 20, wherein the coupler comprises an FeRh alloy.
